(19) United States
(12) Patent Application Publication
(10) Pub. No.: US 2011/0221982 A1
(43) Pub. Date: Sep. 15, 2011

(54) LIQUID CRYSTAL DEVICE AND LIQUID CRYSTAL GLASSES

(75) Inventor: Takaaki TANAKA, Matsumoto-shi (JP)

(73) Assignee: SEIKO EPSON CORPORATION, Tokyo (JP)

(21) Appl. No.: 13/043,689

(22) Filed: Mar. 9, 2011

(30) Foreign Application Priority Data
Mar. 10, 2010 (JP) 2010-053663

(51) Int. Cl. G02F 1/1335

(52) U.S. Cl. 349/13; 349/15; 349/33

(57) ABSTRACT

A liquid crystal device at least includes a first liquid crystal panel assembly and a second liquid crystal panel assembly that overlap with each other, of which slow axes are substantially perpendicular to each other, and in which phase differences decrease due to application of a voltage, a pair of polarizers that is formed to be interposed between the first liquid crystal panel assembly and the second liquid crystal panel assembly, and a control unit that independently controls the voltages applied to the first liquid crystal panel assembly and the second liquid crystal panel assembly.

### BACKGROUND

1. Technical Field

The present invention relates to a liquid crystal device and liquid crystal glasses, and more particularly to a technique enabling the repetition of opening and closing of transmitted light at high speed.

2. Related Art

There is known a stereoscopic display device which enables a viewer to experience stereoscopic vision when a three-dimensional object is displayed on a two-dimensional screen. For example, there is known a method in which right eye images and left eye images respectively corresponding to both the eyes of a human being are misaligned as much as the amount of the binocular parallax and alternately displayed in a time-divisional manner, and a viewer wears dedicated glasses and views the images.

As the dedicated glasses (hereinafter, referred to as stereopsis glasses), there are known liquid crystal glasses in which two liquid crystal shutters are positioned in parallel. For example, during a display period for right eye images, a liquid crystal shutter for the right eye corresponding to the right eye of a viewer is opened (to allow transmission of image light) and a liquid crystal shutter for the left eye is closed. In addition, during a display period for left eye images, the liquid crystal shutter for the left eye corresponding to the left eye of the viewer is opened and the liquid crystal shutter for the right eye is closed. The opening and closing of the liquid crystal shutters for the right eye and the left eye are synchronized with the alternating display of the right eye images and the left eye images, and thereby the viewer can realistically experience stereoscopic vision for the images of the three-dimensional object displayed on the two-dimensional plane.

However, a general characteristic is that the liquid crystal shutter has a problem in that a response speed is low. Particularly, during the fall in an applied voltage, variation in the phase difference is much slower than in the rise in the applied voltage. For this reason, if the liquid crystal shutter is used as the stereopsis glasses, at the time of the change between the right eye images and left eye images, there is a problem in that the right eye images and left eye images are viewed at the same time (crosstalk), and thus the images look blurred.

In order to improve the crosstalk, for example, JP-A-8-171098 discloses that a liquid crystal shutter is formed by overlapping a TN type normally white liquid crystal panel with a TN type normally black liquid crystal panel, and the liquid crystal shutter compensates delay in the phase difference variation during the fall in the applied voltage.

In addition, for example, JP-A-11-38361 discloses a stereoscopic display device in which a liquid crystal shutter is formed using ferroelectric liquid crystal and thus a response speed is improved.

Also, for example, JP-A-2009-152897 discloses a stereoscopic image display device in which the crosstalk is suppressed by opening a liquid crystal shutter only during the vertical blank interval between the display periods for left eye images and right eye images.

However, the liquid crystal shutter disclosed in JP-A-8-171098 has a problem in that at least three polarizers are required, and thus the structure is complex and manufacturing costs are high. In addition, there is concern that images may look dark due to reduction in an amount of light transmitted by the three or more polarizers.

The stereoscopic display device disclosed in JP-A-11-38361 has a problem in that since the ferroelectric liquid crystal is used, the handling thereof is difficult. In other words, the ferroelectric liquid crystal is in a smectic liquid crystal phase and is close to a solid as compared with a nematic liquid crystal phase, and thus, for example, even if a liquid-like C phase is used, the viscosity is high and it is very difficult to inject it into cells of the liquid crystal panel. Also, there are problems in that since the electric field is fixed for a long time, gradients occur in ions inside the liquid crystal and burn-in is easily generated.

In the stereoscopic image display device disclosed in JP-A-2009-152897, since the crosstalk is suppressed by changing display timings in the liquid crystal display which displays left eye images and right eye images, and the opening and closing speed of the liquid crystal shutter is not improved, the effect of prevention of the crosstalk is limited. In addition, there is concern that images are seen to flicker according to the setting of the display timings.

### SUMMARY

An advantage of some aspects of the invention is to provide a liquid crystal device which realizes a high response speed with a relatively simple configuration.

Also, an advantage of another aspect of the invention is to provide liquid crystal glasses capable of efficiently suppressing the generation of crosstalk by using the liquid crystal device having a high response speed as shutters.

In order to solve the above-described problems, several aspects of the invention provide the following liquid crystal device and liquid crystal glasses.

According to an aspect of the invention, there is provided a liquid crystal device including a first liquid crystal panel assembly; a second liquid crystal panel assembly that is formed to overlap with the first liquid crystal panel assembly, of which a slow axis is substantially perpendicular to a slow axis of the first liquid crystal panel assembly, and in which a phase difference increases or decreases due to application of a voltage in the same manner as the first liquid crystal panel assembly; a pair of polarizers that is formed to be interposed between the first liquid crystal panel assembly and the second liquid crystal panel assembly; and a control unit that independently controls the voltages applied to the first liquid crystal panel assembly and the second liquid crystal panel assembly.

In the liquid crystal device according to an aspect of the invention, the first liquid crystal panel assembly and the second liquid crystal panel assembly, in which phase differences decrease or increase together due to application of a voltage, overlap with each other such that slow axes are substantially perpendicular to each other. By using the fact that the variation speed in the phase difference is larger in the rise in the applied voltage than in the fall in the applied voltage in a state where only the first liquid crystal panel assembly is applied with the voltage, it is possible to transfer the liquid crystal device from a closing state to an opening state at high speed. In addition, by using the fact that the variation speed in the phase difference is larger in the rise in the applied voltage than in the fall in the applied voltage in a state where only the second liquid crystal panel assembly is applied with the voltage, it is possible to transfer the liquid crystal device from an opening state to a closing state. Thereby, it is possible to implement the liquid crystal device, which can perform the repetition of closing and opening at high speed, with a relatively simple configuration.

It is preferable that the control unit performs a control such that a rise in the voltage applied to the first liquid crystal panel assembly and a rise in the voltage applied to the second liquid crystal panel assembly are performed at different timings, and a fall in the voltage applied to the first liquid crystal panel assembly and a fall in the voltage applied to the second liquid crystal panel assembly are performed at the same time. Thereby, it is possible to perform variation in a total phase difference in the first liquid crystal panel assembly and the second liquid crystal panel assembly at high speed and implement the liquid crystal device which can perform the repetition of closing and opening at high speed.

It is preferable that a timing when the fall in the voltage applied to the first liquid crystal panel assembly and the fall in the voltage applied to the second liquid crystal panel assembly are performed at the same time is within a period when a total phase difference in the first liquid crystal panel assembly and the second liquid crystal panel assembly becomes minimal. Thereby, it is possible to change a state of the applied voltage in preparation for subsequent phase difference variation without variation in the total phase difference in the first liquid crystal panel assembly and the second liquid crystal panel assembly.

According to an aspect of the invention, there is provided liquid crystal glasses including two liquid crystal devices described above which are disposed in parallel, wherein one liquid crystal device is used as a right eye shutter and the other liquid crystal device is used as a left eye shutter, and wherein when an image display unit which alternately displays a right eye image and a left eye image in a time-divisional manner is viewed, the right eye shutter is opened and the left eye shutter is closed during a display period for the right eye image, and the right eye shutter is closed and the left eye shutter is opened during a display period for the left eye image.

According to the liquid crystal glasses, by using the fact that the variation speed in the phase difference is larger in the rise in the applied voltage than in the fall in the applied voltage in a state where only the first liquid crystal panel assembly is applied with the voltage, it is possible to transfer the liquid crystal device from a closing state to an opening state at high speed. In addition, by using the fact that the variation speed in the phase difference is larger in the rise in the applied voltage than in the fall in the applied voltage in a state where only the second liquid crystal panel assembly is applied with the voltage, it is possible to transfer the liquid crystal device from an opening state to a closing state. Therefore, it is possible to transfer the right eye liquid crystal shutter (liquid crystal device) and the left eye liquid crystal shutter (liquid crystal device) to the opening state at high speed. Thereby, it is possible to prevent the generation of a so-called crosstalk in which a viewer views the right eye image and the left eye image together, and to clearly view three-dimensional images without being blurred.

It is preferable that a receiving unit which receives timing signals generated so as to correspond to display changing between the right eye image and the left eye image is further provided. Thereby, the changing in the display images and the left and right shutters of the liquid crystal glasses can be performed without being shifted.

It is preferable that when display changing between the right eye image and the left eye image is performed, the right eye shutter and the left eye shutter are simultaneously closed only during a predetermined period. Thereby, it is possible to more reliably prevent the generation of crosstalk in which a viewer views the right eye image and the left eye image together in a blurred state during the display changing between left eye image and the right eye image.

### BRIEF DESCRIPTION OF THE DRAWINGS

The invention will be described with reference to the accompanying drawings, wherein like numbers reference like elements.

FIG. 1 is a schematic configuration diagram illustrating a liquid crystal shutter which is an example of a liquid crystal device according to an embodiment of the invention.

FIG. 2 is a diagram illustrating an angle relationship between slow axes and transmission axes of the respective members constituting the liquid crystal shutter.

FIGS. 3A to 3C are diagrams illustrating a first liquid crystal panel assembly and a second liquid crystal panel assembly constituting a liquid crystal shutter according to a first embodiment.

FIG. 4 is a diagram illustrating an operation of the liquid crystal shutter according to the first embodiment.

FIGS. 5A to 5C are diagrams illustrating a first liquid crystal panel assembly and a second liquid crystal panel assembly constituting a liquid crystal shutter according to a second embodiment.

FIG. 6 is a diagram illustrating an operation of the liquid crystal shutter according to the second embodiment.

FIG. 7 is a schematic diagram illustrating a stereoscopic image viewing system using liquid crystal glasses.

FIG. 8 is an enlarged cross-sectional view illustrating main parts of liquid crystal glasses provided with the liquid crystal device according to an embodiment of the invention.

FIG. 9 is a diagram illustrating an operation of the liquid crystal glasses according to an embodiment of the invention.

### DESCRIPTION OF EXEMPLARY EMBODIMENTS

Hereinafter, a liquid crystal device according to an embodiment of the invention will be described with reference to the accompanying drawings. Also, the embodiment is described in detail for better understanding of the invention, and thus does not limit the invention unless particularly designated otherwise. In the drawings used for the following description, in some cases, for convenience, main parts are enlarged for better understanding of the features of the invention, and thus dimensions or the like of respective constituent elements may be different from actual ones.

### Liquid Crystal Device: First Embodiment

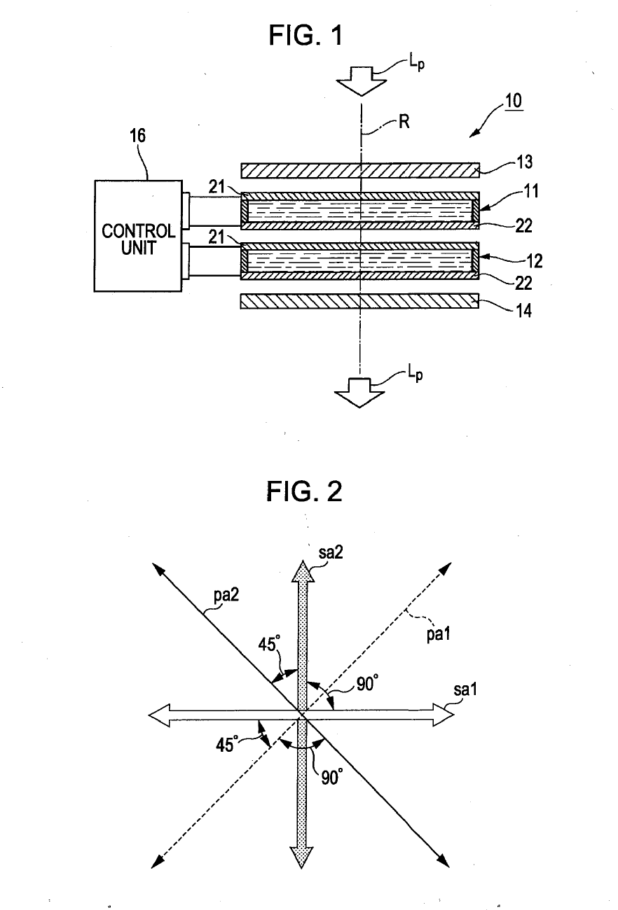

FIG. 1 is a configuration diagram illustrating an outline of a liquid crystal shutter which is an example of the liquid crystal device according to an embodiment of the invention.

A liquid crystal shutter (liquid crystal device) 10 according to the first embodiment is disposed, for example, in a light path R from an incidence side of light to an emission side thereof, and controls transmission and blocking of transmitted light Lp. Hereinafter, an opening state of the liquid crystal shutter 10 indicates a state where the transmitted light Lp is allowed to be transmitted, and a closing state indicates a state where the transmitted light Lp is hindered (blocked) from being transmitted.

The liquid crystal shutter (liquid crystal device) 10 includes a first liquid crystal panel assembly 11, a second liquid crystal panel assembly 12, and a first polarizer 13 and a second polarizer 14 forming a pair of polarizers interposed between the first liquid crystal panel assembly 11 and the second liquid crystal panel assembly 12. In addition, a control unit 16 which independently controls voltages applied to the first liquid crystal panel assembly 11 and the second liquid crystal panel assembly 12 is provided.

FIG. 2 is a schematic diagram illustrating an angle relationship between slow axes and transmission axes of the respective constituent elements of the liquid crystal shutter (liquid crystal device) 10. FIG. 2 shows a state of being viewed from above with respect to an optical axis of the liquid crystal shutter 10.

The slow axis sa1 of the first liquid crystal panel assembly 11 is disposed to be perpendicular to the slow axis sa2 of the second liquid crystal panel assembly 12, at about 90°.

Further, the transmission axis pa1 of the first polarizer 13 and the transmission axis pa2 of the second polarizer 14 are disposed so as to be perpendicular to each other at about 90°, and the transmission axis pa1 of the first polarizer 13 and the transmission axis pa2 of the second polarizer 14 are all disposed so as to intersect the slow axis sa1 of the first liquid crystal panel assembly 11 and the slow axis sa2 of the second liquid crystal panel assembly 12, at about 45°. In other words, the respective constituent elements overlap with each other such that the slow axis sa1 (the first liquid crystal panel assembly 11), the slow axis sa2 (the second liquid crystal panel assembly 12), the transmission axis pa1 (the first polarizer 13), and the transmission axis pa2 (the second polarizer 14) intersect each other at about 45°.

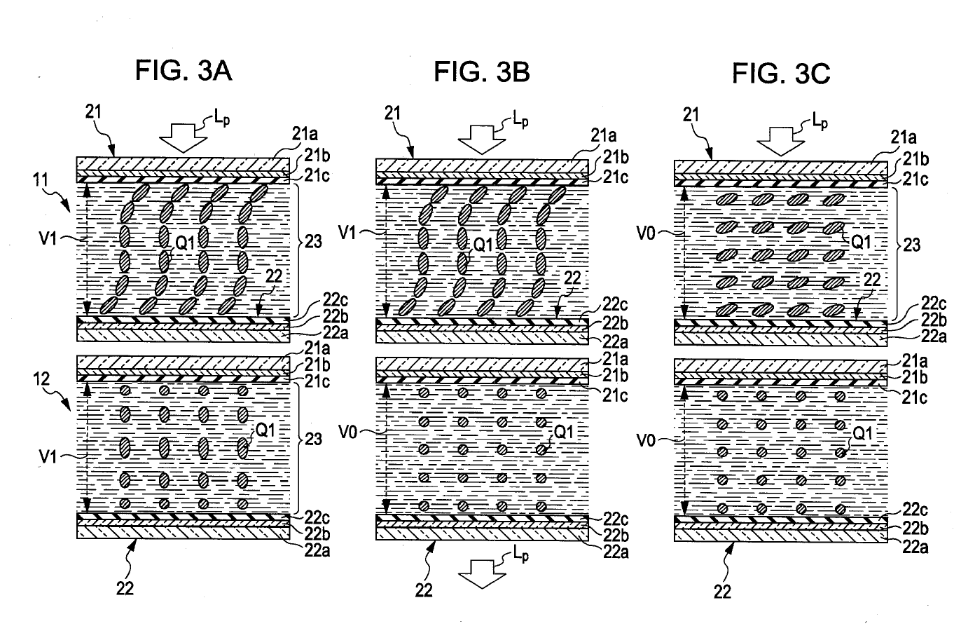

FIGS. 3A to 3C are diagrams illustrating examples of the first liquid crystal panel assembly 11 and the second liquid crystal panel assembly 12.

The first liquid crystal panel assembly 11 and the second liquid crystal panel assembly 12 have the same structure and overlap with each other such that the slow axes thereof are substantially perpendicular to each other. The first liquid crystal panel assembly 11 and the second liquid crystal panel assembly 12 may use a horizontally aligned type liquid crystal device in which a phase difference decreases during the application of a voltage. Each of the first liquid crystal panel assembly 11 and the second liquid crystal panel assembly 12 includes an upper panel 21, a lower panel 22 disposed opposite thereto, and a liquid crystal layer 23 interposed between the upper panel 21 and the lower panel 22.

The upper panel 21 has a substrate 21a which is a base made of a translucent material such as glass or quartz, an upper electrode 21b which is made of a transparent conductive material such as ITO (indium tin oxide) on one surface of the substrate 21a, and an alignment layer 21c made of silicon oxide or the like, which are sequentially laminated. The alignment layer 21c is rubbed in a predetermined direction.

In addition, the lower panel (opposite panel) 22 has a substrate 22a which is a base made of a translucent material such as glass or quartz, an lower electrode 22b the inside of which is made of a transparent conductive material such as ITO, and an alignment layer 22c made of silicon oxide, which are sequentially laminated. The alignment layer 22c is also rubbed in a direction which is the same as the rubbing direction in the alignment layer 21c. The liquid crystal layer 23 includes liquid crystal having a positive dielectric anisotropy.

As shown in FIG. 3A, in a voltage application state where a voltage V1 of a predetermined value is applied between the upper electrode 21b and the lower electrode 22b of each of the first liquid crystal panel assembly 11 and the second liquid crystal panel assembly 12, the liquid crystal molecules Q1 in the alignment layer 21c side of the upper panel 21 and the alignment layer 22c side of the lower panel 22 are aligned in the roughly horizontal direction with a predetermined pre-tilt angle, and the liquid crystal molecules Q1 therebetween are aligned so as to stand in the roughly vertical direction (since the slow axes of the first liquid crystal panel assembly 11 and the second liquid crystal panel assembly 12 overlap with each other so as to be substantially perpendicular to each other, the shown sides of the liquid crystal molecules of the first liquid crystal panel assembly 11 and the second liquid crystal panel assembly 12 in FIGS. 3A to 3C are misaligned by 90°).

In this way, if the voltage V1 is applied to the first liquid crystal panel assembly 11 and the second liquid crystal panel assembly 12, the phase difference in all the first liquid crystal panel assembly 11 and the second liquid crystal panel assembly 12 becomes 0 (or becomes minimal). As a result, the total phase difference becomes minimal if not 0 in the state where the first liquid crystal panel assembly 11 and the second liquid crystal panel assembly 12 overlap with each other, since mutual phase differences get balanced out. Therefore, the transmitted light Lp incident to the first liquid crystal panel assembly 11 is hindered from being emitted from the second liquid crystal panel assembly 12 (a blocking state of the transmitted light Lp).

As shown in FIG. 3B, in the voltage application state where the voltage V1 of a predetermined value is applied between the upper electrode 21b and the lower electrode 22b of the first liquid crystal panel assembly 11, if the second liquid crystal panel assembly 12 enters a voltage non-application state where a voltage is not applied between the upper electrode 21b and the lower electrode 22b, the phase difference (retardation) in the first liquid crystal panel assembly 11 becomes maximal. On the other hand, in the second liquid crystal panel assembly 12, the liquid crystal molecules Q1 are aligned with a predetermined pre-tilt angle in the roughly horizontal direction, and the phase difference becomes minimal if not 0. Thereby, since the phase difference becomes maximal (λ/2) in the state where the first liquid crystal panel assembly 11 and the second liquid crystal panel assembly 12 overlap with each other, the transmitted light Lp incident to the first liquid crystal panel assembly 11 is allowed to be emitted from the second liquid crystal panel assembly 12 (a transmitting state of the transmitted light Lp).

In addition, as shown in FIG. 3C, in the voltage non-application state where a voltage is not applied between the upper electrode 21b and the lower electrode 22b of each of the first liquid crystal panel assembly 11 and second liquid crystal panel assembly 12, all the phase differences (retardation) in the first liquid crystal panel assembly 11 and the second liquid crystal panel assembly 12 become maximal. However, since the slow axes of the first liquid crystal panel assembly 11 and the second liquid crystal panel assembly 12 overlap with each other so as to be substantially perpendicular to each other, mutual phase differences cancel each other out. Thereby, the total phase difference becomes 0 (or becomes minimal) in the state where the first liquid crystal panel assembly 11 and the second liquid crystal panel assembly 12 overlap with each other. Therefore, the transmitted light Lp incident to the first liquid crystal panel assembly 11 is hindered from being emitted from the second liquid crystal panel assembly 12 (a blocking state of the transmitted light Lp).

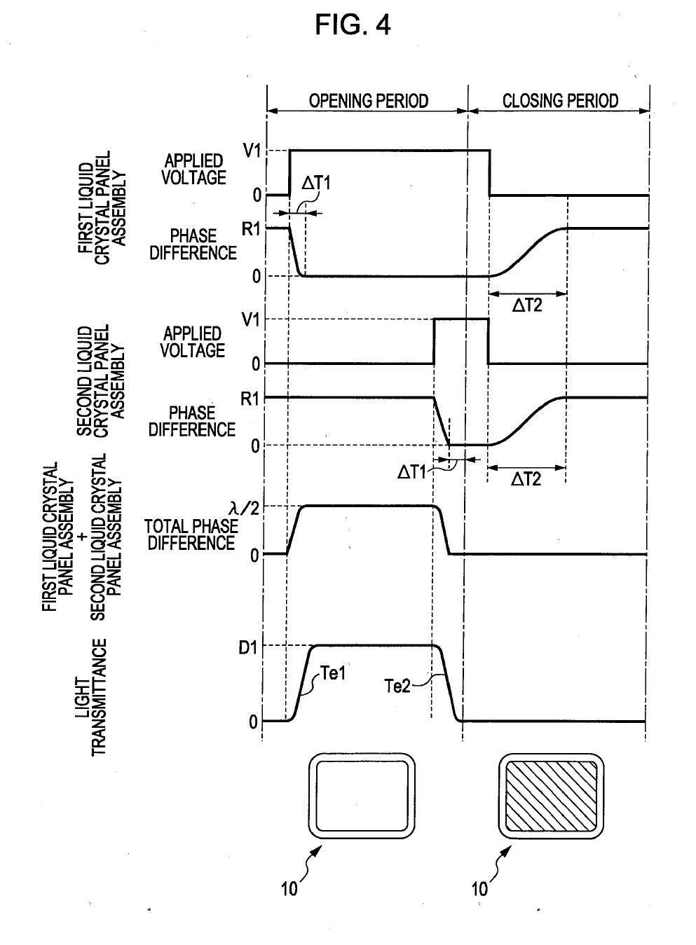

An operation of the liquid crystal shutter (liquid crystal device) 10 according to an embodiment of the invention configured in this way will be described with reference to FIGS. 3 and 4. FIG. 4 is a diagram illustrating an operation of the liquid crystal shutter.

The liquid crystal shutter (liquid crystal device) 10 may have two states, that is, an opening state of allowing the transmitted light Lp to be transmitted and a closing state of blocking the transmitted light Lp from being transmitted, and, thereby, plays a part of a shutter for the transmitted light. In FIG. 4, an opening period indicates a period when the liquid crystal shutter 10 is in the opening state and a closing period indicates a period when the liquid crystal shutter 10 in the closing state.

In FIG. 4, if liquid crystal shutter 10 is transferred to the opening state from the closing state, a predetermined voltage V1 from an applied voltage 0 is applied to the first liquid crystal panel assembly 11. That is to say, the waveform of the applied voltage rises. Thereby, the phase difference in the first liquid crystal panel assembly 11 varies to 0 (no phase difference) from the maximal phase difference R1. The phase difference 0 described below includes not only the phase difference 0 as an absolute value but also the minimum in a range where a phase difference in the liquid crystal panel assembly can be selected.

On the other hand, during the opening period in the liquid crystal shutter 10, a state continues in which a voltage is not applied to the second liquid crystal panel assembly 12 (voltage 0). The second liquid crystal panel assembly 12 becomes the maximum R1 in the phase difference in this voltage non-application state. In other words, the phase difference becomes an absolute value of a difference between the maximal phase difference in the first liquid crystal panel assembly 11 and the minimal phase difference in the second liquid crystal panel assembly 12.

As a result, the phase difference (the total phase difference) in the liquid crystal shutter 10 in the state where the first liquid crystal panel assembly 11 of the phase difference 0 overlaps with the second liquid crystal panel assembly 12 of the phase difference R1 becomes λ/2. Therefore, the transmittance of light in the liquid crystal shutter 10 becomes D1, that is, the liquid crystal shutter 10 enters the opening state of allowing the transmitted light to be transmitted (refer to FIG. 3B).

When the liquid crystal shutter 10 is transferred from the closing state to the opening state, since the rise in the voltage applied to the first liquid crystal panel assembly 11 is used, the phase difference can decrease from R1 to 0 for a relatively short delay time ΔT1 (much shorter than the delay time ΔT2 when the phase difference varies during the fall in the applied voltage). Therefore, when the liquid crystal shutter 10 is transferred to the opening state, the transmittance can steeply vary (refer to the line Te1 in FIG. 4).

Next, if the opening period in the liquid crystal shutter 10 is nearly finished, the voltage applied to the second liquid crystal panel assembly 12 rises to V1 this time in the state where the voltage applied to the first liquid crystal panel assembly 11 is maintained as V1. Thereby, the phase difference in the second liquid crystal panel assembly 12 varies to 0 (no phase difference) from the maximal phase difference R1, and the total phase difference in the first liquid crystal panel assembly 11 and the second liquid crystal panel assembly 12 becomes 0. Therefore, the transmittance of light in the liquid crystal shutter 10 becomes 0, that is, the liquid crystal shutter 10 enters the blocking state of transmitted light (refer to FIG. 3A).

When the liquid crystal shutter 10 is transferred from the opening state to the closing state, since the rise in the voltage applied to the second liquid crystal panel assembly 12 is used, the total phase difference can decrease from λ/2 to 0 for a relatively short delay time ΔT1 (much shorter than the delay time ΔT2 when the phase difference varies during the fall in the applied voltage). Therefore, when the liquid crystal shutter 10 is transferred to the closing state as well, the transmittance can steeply vary (refer to the line Te2 in FIG. 4).

Next, in order to prepare for the subsequent opening period during the closing period in the liquid crystal shutter 10, the voltage applied to each of the first liquid crystal panel assembly 11 and the second liquid crystal panel assembly 12 falls to 0 from V1. It is preferable that the fall in the applied voltage during the closing period is performed at the same timing in the first liquid crystal panel assembly 11 and the second liquid crystal panel assembly 12.

In other words, since the slow axes of the first liquid crystal panel assembly 11 and the second liquid crystal panel assembly 12 overlap with each other so as to be substantially perpendicular to each other, if the respective phase differences in the first liquid crystal panel assembly 11 and the second liquid crystal panel assembly 12 are equally varied by the same variation speed, the mutual phase differences in the liquid crystal panel assemblies cancel each other out, and thus the total phase difference in the first liquid crystal panel assembly 11 and the second liquid crystal panel assembly 12 is maintained to be 0.

As a result, the voltage applied to each of the first liquid crystal panel assembly 11 and the second liquid crystal panel assembly 12 can fall to 0 from V1 in the state where the liquid crystal shutter 10 is maintained to be in the closing state. Further, it is possible to perform the high speed transfer to the opening state using the rise in the voltage applied to the first liquid crystal panel assembly 11 and the high speed transfer to the closing state using the rise in the voltage applied to the second liquid crystal panel assembly 12, during the subsequent opening period.

In this way, during the closing period, in order to equally change the respective phase differences in the first liquid crystal panel assembly 11 and the second liquid crystal panel assembly 12 at the same variation speed, the first liquid crystal panel assembly 11 and the second liquid crystal panel assembly 12 use the two liquid crystal panel assemblies having the same structure in this embodiment, but liquid crystal panel assemblies having different structures (types) may be combined as long as the phase differences of the first liquid crystal panel assembly 11 and the second liquid crystal panel assembly 12 can be roughly equally changed at the same variation speed.

As described above, according to the liquid crystal shutter (liquid crystal device) 10 in this embodiment, the slow axes of the first liquid crystal panel assembly 11 and the second liquid crystal panel assembly 12, in which the phase difference decreases due to the voltage application, overlap with each other so as to be substantially perpendicular to each other. Further, the voltage is applied only to the first liquid crystal panel assembly 11, the variation speed in the phase difference is higher in the rise in the applied voltage than in the fall in the applied voltage, and thereby the liquid crystal shutter 10 can be transferred to the opening state from the closing state at high speed. In addition, the voltage is applied only to the second liquid crystal panel assembly 12, the variation speed in the phase difference is higher in the rise in the applied voltage than in the fall in the applied voltage, and thereby the liquid crystal shutter 10 can be transferred to the closing state from the opening state at high speed. Thereby, it is possible to implement the liquid crystal shutter, which can perform the repetition of closing and opening at high speed, with a relatively simple configuration.

### Liquid Crystal Device: Second Embodiment

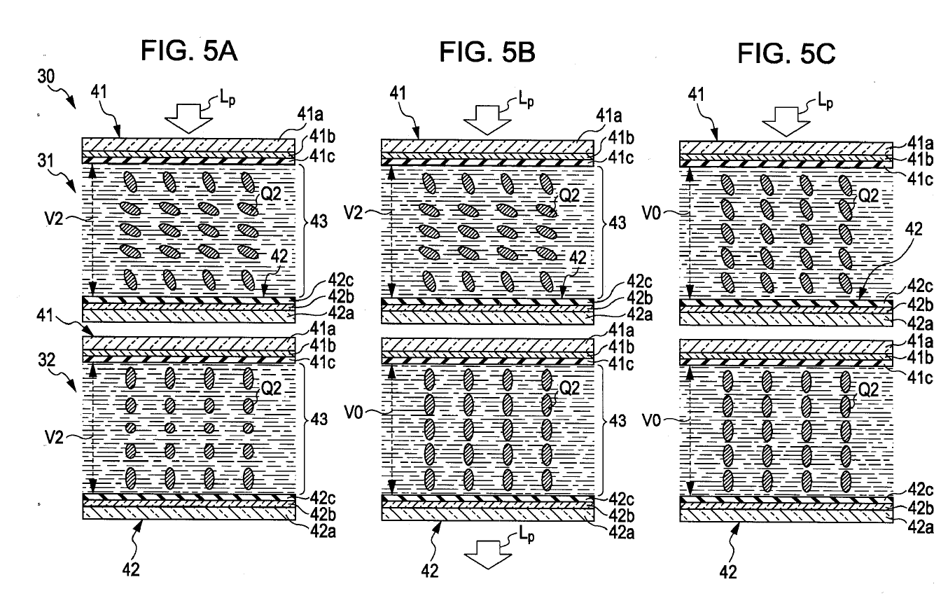

FIGS. 5A to 5C are diagrams illustrating examples of a first liquid crystal panel assembly and a second liquid crystal panel assembly according to a second embodiment.

The first liquid crystal panel assembly 31 and the second liquid crystal panel assembly 32 constituting the liquid crystal shutter (liquid crystal device) 30 according to the second embodiment have the same structure and overlap with each other such that the slow axes thereof are substantially perpendicular to each other. The first liquid crystal panel assembly 31 and the second liquid crystal panel assembly 32 may use a tilt vertical alignment type liquid crystal device in which a phase difference increases during the application of a voltage. Each of the first liquid crystal panel assembly 31 and the second liquid crystal panel assembly 32 includes an upper panel 41, a lower panel 42 disposed opposite thereto, and a liquid crystal layer 43 interposed between the upper panel 41 and the lower panel 42.

The upper panel 41 has a substrate 41a which is a base made of a translucent material such as glass or quartz, an upper electrode 41b which is made of a transparent conductive material such as ITO (indium tin oxide) on one surface of the substrate 41a, and an alignment layer 41c made of silicon oxide or the like, which are sequentially laminated. The alignment layer 41c is rubbed in a predetermined direction.

In addition, the lower panel (opposite panel) 42 has a substrate 42a which is a base made of a translucent material such as glass or quartz, an lower electrode 42b the inside of which is made of a transparent conductive material such as ITO, and an alignment layer 42c made of silicon oxide, which are sequentially laminated. The alignment layer 42c is also rubbed in a direction which is the same as the rubbing direction in the alignment layer 42c. The liquid crystal layer 43 includes liquid crystal having a negative dielectric anisotropy.

In the liquid crystal shutter (liquid crystal device) 30 as well, in the same manner as the first embodiment, the slow axis of the first liquid crystal panel assembly 31 is disposed to be perpendicular to the slow axis of the second liquid crystal panel assembly 32 at about 90°. Further, the transmission axes of a pair of polarizers interposed between the first liquid crystal panel assembly 31 and the second liquid crystal panel assembly 32 are disposed so as to be perpendicular to each other at about 90°. Also, the transmission axis each of the pair of the polarizers is disposed so as to intersect the slow axis of the first liquid crystal panel assembly 31 and the slow axis of the second liquid crystal panel assembly 32 at about 45°.

As shown in FIG. 5A, in a voltage application state where a voltage V2 of a predetermined value is applied between the upper electrode 41b and the lower electrode 42b of each of the first liquid crystal panel assembly 31 and the second liquid crystal panel assembly 32, the liquid crystal molecules Q2 in the alignment layer 41c side of the upper panel 41 and the alignment layer 42c side of the lower panel 42 are aligned in the roughly vertical direction with a predetermined pre-tilt angle, and the liquid crystal molecules Q2 therebetween are aligned so as to extend in the roughly horizontal direction (since the slow axes of the first liquid crystal panel assembly 31 and the second liquid crystal panel assembly 32 overlap with each other so as to be substantially perpendicular to each other, the shown sides of the liquid crystal molecules of the first liquid crystal panel assembly 31 and the second liquid crystal panel assembly 32 in FIGS. 5A to 5C are misaligned by 90°).

In this way, if the voltage V2 is applied to the first liquid crystal panel assembly 31 and second liquid crystal panel assembly 32, all the phase differences (retardation) in the first liquid crystal panel assembly 31 and the second liquid crystal panel assembly 32 become maximal. However, since the slow axes of the first liquid crystal panel assembly 31 and the second liquid crystal panel assembly 32 overlap with each other so as to be substantially perpendicular to each other, mutual phase differences cancel each other out. Thereby, the total phase difference becomes 0 (or becomes minimal) in the state where the first liquid crystal panel assembly 31 and the second liquid crystal panel assembly 32 overlap with each other. Therefore, the transmitted light Lp incident to the first liquid crystal panel assembly 31 is hindered from being emitted from the second liquid crystal panel assembly 32 (a blocking state of the transmitted light Lp).

As shown in FIG. 5B, in the voltage application state where the voltage V2 of a predetermined value is applied between the upper electrode 41b and the lower electrode 42b of the first liquid crystal panel assembly 31, if the second liquid crystal panel assembly 32 enters a voltage non-application state where a voltage is not applied between the upper electrode 41b and the lower electrode 42b, the phase difference (retardation) in the first liquid crystal panel assembly 31 becomes maximal. On the other hand, in the second liquid crystal panel assembly 32, the liquid crystal molecules Q2 are aligned with a predetermined pre-tilt angle in the roughly vertical direction, and the phase difference becomes minimal if not 0. Thereby, since the total phase difference becomes maximal (λ/2) in the state where the first liquid crystal panel assembly 31 and the second liquid crystal panel assembly 32 overlap with each other, the transmitted light Lp incident to the first liquid crystal panel assembly 31 is allowed to be emitted from the second liquid crystal panel assembly 32 (a transmitting state of the transmitted light Lp).

In addition, as shown in FIG. 5C, in the voltage non-application state where a voltage is not applied (V0) between the upper electrode 41b and the lower electrode 42b of each of the first liquid crystal panel assembly 31 and second liquid crystal panel assembly 32, the phase difference in all the first liquid crystal panel assembly 31 and the second liquid crystal panel assembly 32 becomes 0 (or becomes minimal). As a result, the total phase difference becomes minimal if not 0 in the state where the first liquid crystal panel assembly 31 and the second liquid crystal panel assembly 32 overlap with each other. Therefore, the transmitted light Lp incident to the first liquid crystal panel assembly 31 is hindered from being emitted from the second liquid crystal panel assembly 32 (a blocking state of the transmitted light Lp).

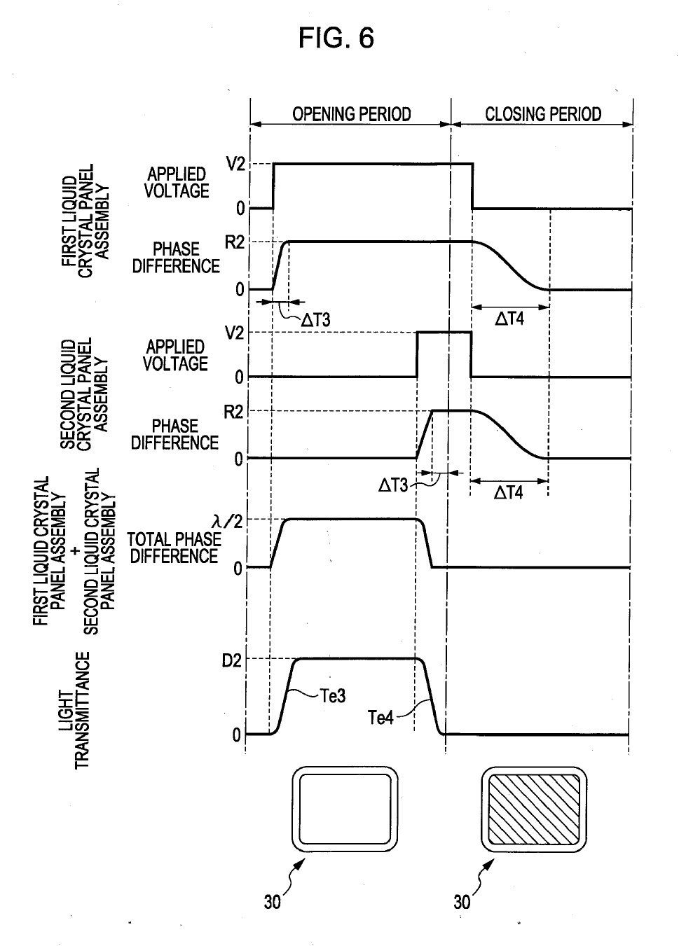

An operation of the liquid crystal shutter according to the second embodiment of the invention configured in this way will be described with reference to FIGS. 5 and 6. FIG. 6 is a diagram illustrating an operation of the liquid crystal shutter.

In FIG. 6, if liquid crystal shutter 30 is transferred to the opening state from the closing state, a predetermined voltage V2 from an applied voltage 0 is applied to the first liquid crystal panel assembly 31. That is to say, the waveform of the applied voltage rises. Thereby, the phase difference in the first liquid crystal panel assembly 31 varies from 0 (no phase difference) to the maximal phase difference R2.

On the other hand, during the opening period in the liquid crystal shutter 30, a state continues in which a voltage is not applied to the second liquid crystal panel assembly 32 (voltage 0). The second liquid crystal panel assembly 32 becomes 0 (no phase difference) in the phase difference in this voltage non-application state.

As a result, the phase difference (the total phase difference) in the liquid crystal shutter 30 in the state where the first liquid crystal panel assembly 31 of the phase difference R2 overlaps with the second liquid crystal panel assembly 32 of the phase difference 0 becomes λ/2. Therefore, the transmittance of light in the liquid crystal shutter 30 becomes D2, that is, the liquid crystal shutter 30 enters the opening state of allowing the transmitted light to be transmitted (refer to FIG. 5B).

When the liquid crystal shutter 30 is transferred from the closing state to the opening state, since the rise in the voltage applied to the first liquid crystal panel assembly 31 is used, the phase difference can increase from 0 to R2 for a relatively short delay time ΔT3 (much shorter than the delay time ΔT4 when the phase difference varies during the fall in the applied voltage). Therefore, when the liquid crystal shutter 30 is transferred to the opening state, the transmittance can steeply vary (refer to the line Te3 in FIG. 6).

Next, if the opening period in the liquid crystal shutter 30 is nearly finished, the voltage applied to the second liquid crystal panel assembly 32 rises to V2 this time in the state where the voltage applied to the first liquid crystal panel assembly 31 is maintained as V2. Thereby, the phase difference in the second liquid crystal panel assembly 32 increases to R2 from 0, and the total phase difference in the first liquid crystal panel assembly 31 and the second liquid crystal panel assembly 32 becomes 0. Therefore, the transmittance of light in the liquid crystal shutter 30 becomes 0, that is, the liquid crystal shutter 30 enters the blocking state of transmitted light (refer to FIG. 5A).

When the liquid crystal shutter 30 is transferred from the opening state to the closing state, since the rise in the voltage applied to the second liquid crystal panel assembly 32 is used, the total phase difference can decrease from λ/2 to 0 for a relatively short delay time ΔT3 (much shorter than the delay time ΔT4 when the phase difference varies during the fall in the applied voltage). Therefore, when the liquid crystal shutter 30 is transferred to the closing state as well, the transmittance can steeply vary (refer to the line Te4 in FIG. 6).

Next, in order to prepare for the subsequent opening period during the closing period in the liquid crystal shutter 30, the voltage applied to each of the first liquid crystal panel assembly 31 and the second liquid crystal panel assembly 32 falls to 0 from V2. It is preferable that the fall in the applied voltage during the closing period is performed at the same timing in the first liquid crystal panel assembly 31 and the second liquid crystal panel assembly 32.

In other words, since the slow axes of the first liquid crystal panel assembly 31 and the second liquid crystal panel assembly 32 overlap with each other so as to be substantially perpendicular to each other, if the respective phase differences in the first liquid crystal panel assembly 31 and the second liquid crystal panel assembly 32 are equally varied by the same variation speed, the mutual phase differences in the liquid crystal panel assemblies cancel each other out, and thus the total phase difference in the first liquid crystal panel assembly 31 and the second liquid crystal panel assembly 32 is maintained to be 0.

As a result, the voltage applied to each of the first liquid crystal panel assembly 31 and the second liquid crystal panel assembly 32 can fall to 0 from V2 in the state where the liquid crystal shutter 30 is maintained to be in the closing state. Further, it is possible to perform the high speed transfer to the opening state using the rise in the voltage applied to the first liquid crystal panel assembly 31 and the high speed transfer to the closing state using the rise in the voltage applied to the second liquid crystal panel assembly 32, during the subsequent opening period.

### Liquid Crystal Glasses

Next, liquid crystal glasses using the above-described liquid crystal shutter (liquid crystal device) according to an embodiment of the invention will be described.

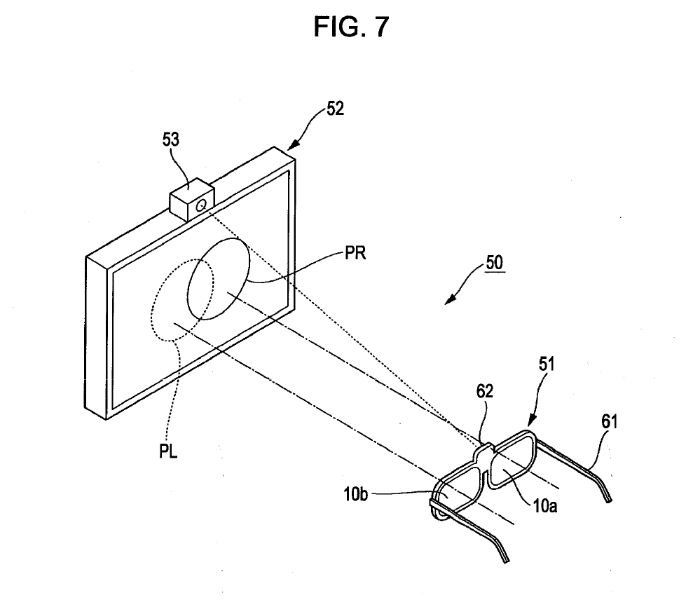

FIG. 7 is a schematic diagram illustrating a stereoscopic image viewing system using liquid crystal glasses. The stereoscopic image viewing system 50 includes liquid crystal glasses 51 and a stereoscopic image display device 52. The stereoscopic image display device 52 alternately displays a right eye image PR and a left eye image PL which are misaligned with a distance corresponding to the parallax W of the right eye and left eye of a viewer (human being) at predetermined timings. The stereoscopic image display device 52 is provided with a timing signal generator 53 which generates signals in synchronization with the changing timing between the right eye image PR and the left eye image PL.

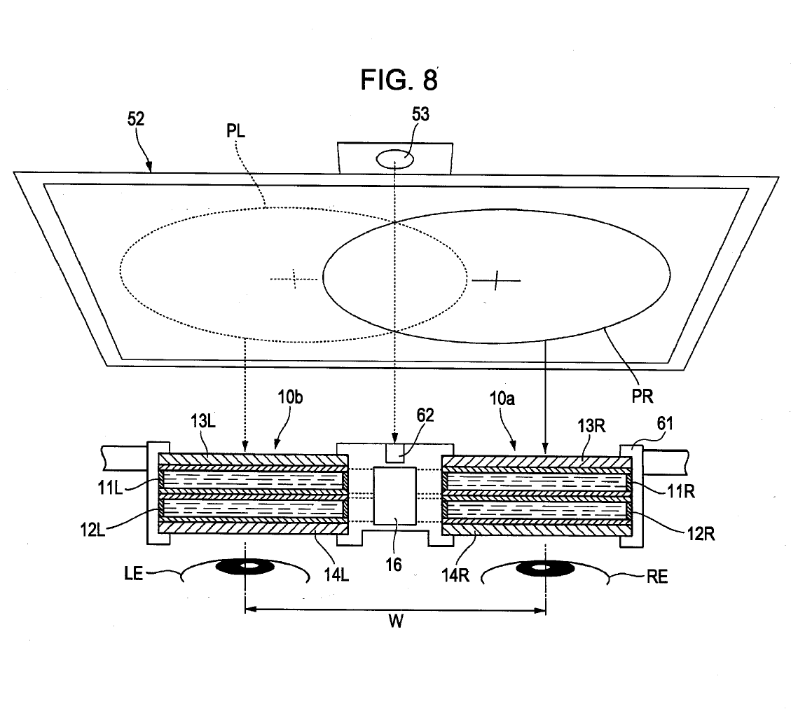

FIG. 8 is an enlarged cross-sectional view illustrating main parts of the liquid crystal glasses.

The liquid crystal glasses 51 include, for example, two liquid crystal shutters (liquid crystal device) 10, shown in the first embodiment, which are disposed in parallel and a glasses frame 61 supporting the two liquid crystal shutters 10a and 10b. Among them, the liquid crystal shutter 10a is positioned in the line of sight for the right eye RE of the viewer, and the liquid crystal shutter 10b is positioned in the line of sight for the left eye LE (hereinafter, respectively also referred tows a left eye shutter and a right eye shutter). Further, the glasses frame 61 is provided with a timing signal receiving unit 62 which receives timing signals generated from the timing signal generator 53.

The right eye liquid crystal shutter 10a includes a first liquid crystal panel assembly 11R, a second liquid crystal panel assembly 12R, and a first polarizer 13R and a second polarizer 14R forming a pair of polarizers which is interposed between the first liquid crystal panel assembly 11R and the second liquid crystal panel assembly 12R. In addition, an optical compensation plate 15R is provided between the first polarizer 13R and the first liquid crystal panel assembly 11R.

In the same manner, the left eye liquid crystal shutter 10b includes a first liquid crystal panel assembly 11L, a second liquid crystal panel assembly 12L, and a first polarizer 13L and a second polarizer 14L forming a pair of polarizers which is interposed between the first liquid crystal panel assembly 11L and the second liquid crystal panel assembly 12L.

A control unit 16, which collectively applies voltages to the first liquid crystal panel assembly 11R and the second liquid crystal panel assembly 12R constituting the right eye liquid crystal shutter 10a and the first liquid crystal panel assembly 11L and the second liquid crystal panel assembly 12L constituting the left eye liquid crystal shutter 10b, is provided in the glasses frame 61. The control unit 16 is supplied with a signal received by the timing signal receiving unit 62.

The first liquid crystal panel assemblies 11L and 11R and the second liquid crystal panel assemblies 12L and 12R may all be horizontally aligned type liquid crystal devices in which the phase difference decreases during the application of a voltage in the same manner as the first liquid crystal panel assembly 11 and the second liquid crystal panel assembly 12 in the first embodiment.

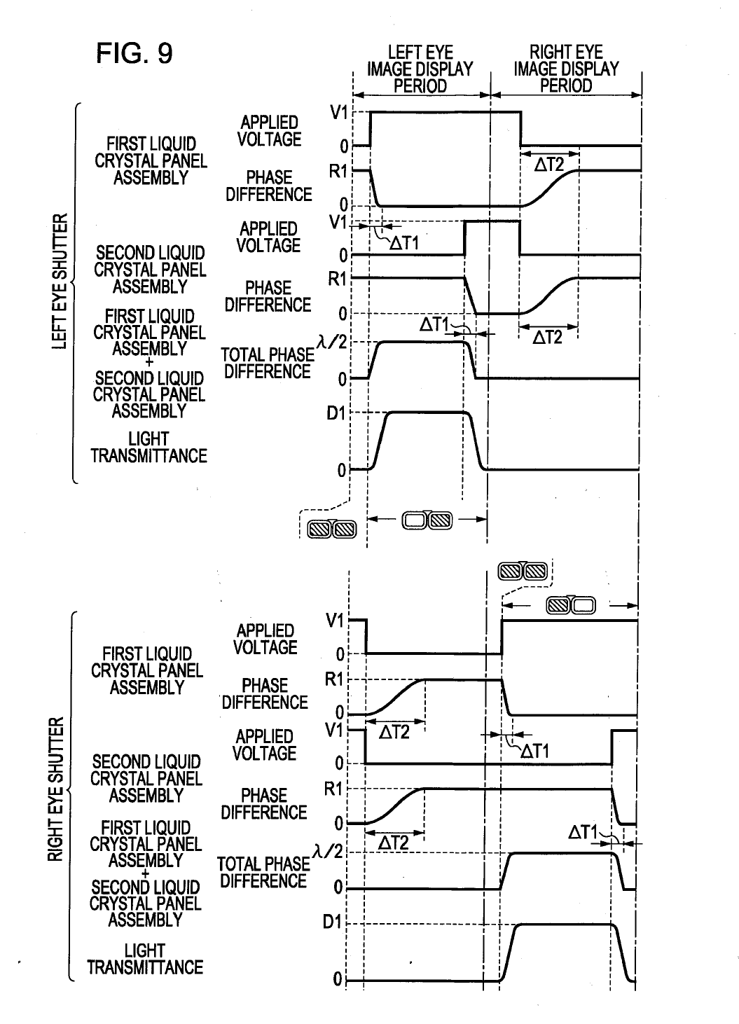

An operation of the liquid crystal glasses 51 configured as described above will be described with reference to FIGS. 8 and 9. FIG. 9 is a diagram illustrating a shutter operation of the liquid crystal glasses.

The liquid crystal glasses 51 open the left eye liquid crystal shutter 10b and close the right eye liquid crystal shutter 10a during the left eye image display period when the left eye image PL is displayed in the stereoscopic image display device 52. In addition, the liquid crystal glasses 51 open the right eye liquid crystal shutter 10a and close the left eye liquid crystal shutter 10b during the right eye image display period when the right eye image PR is displayed in the stereoscopic image display device 52.

In this way, the liquid crystal glasses 51 alternately change between the opening and the closing of the liquid crystal shutters for the right eye and left eye during the left eye image display period and the right eye image display period. The changing between the opening and the closing of the liquid crystal shutter 10a and the left eye liquid crystal shutter 10b is performed by the input signal received by the timing signal receiving unit 62.

In other words, in the stereoscopic image display device 52, the timing signal generator 53 generates timing signals when the display is changed from the left eye image PL to the right eye image PR and when the display is changed from the right eye image PR to the left eye image PL. The timing signal receiving unit 62 of the liquid crystal glasses 51 outputs the received timing signals to the control unit 16 if the timing signals are generated. The control unit 16 respectively controls voltages applied to the first liquid crystal panel assembly 11R and the second liquid crystal panel assembly 12R constituting the right eye liquid crystal shutter 10a and the first liquid crystal panel assembly 11L and the second liquid crystal panel assembly 12L constituting the left eye liquid crystal shutter 10b.

As shown in FIG. 9, when the stereoscopic image display device 52 enters the left eye image display period, the liquid crystal glasses 51 are transferred to the opening state of the left eye liquid crystal shutter 10b. In the state where a voltage applied to the second liquid crystal panel assembly 12L is maintained to be 0 (to fall), a voltage applied to the first liquid crystal panel assembly 11L rises to V1. Thereby, the phase difference in the first liquid crystal panel assembly 11L decreases from R1 to 0. As a result, the phase difference (the total phase difference) in the liquid crystal shutter 10b in the state where the first liquid crystal panel assembly 11L of the phase difference 0 overlaps with the second liquid crystal panel assembly 12L of the phase difference R1 becomes λ/2. Therefore, the transmittance of light in the liquid crystal shutter 10b becomes D1, thus the left eye liquid crystal shutter 10b enters the opening state of transmitting image light for the left eye image PL, and thereby the left eye LE of the viewer can recognize the left eye image PL.

When the liquid crystal shutter 10b is transferred from the closing state to the opening state, since the rise in the voltage applied to the first liquid crystal panel assembly 11L is used, the phase difference can decrease from R1 to 0 for a relatively short delay time ΔT1 (much shorter than the delay time ΔT2 when the phase difference varies during the fall in the applied voltage). Therefore, when the liquid crystal shutter 10b is transferred to the opening state, the transmittance can steeply vary.

On the other hand, the right eye liquid crystal shutter 10a is transferred to the closing state if the stereoscopic image display device 52 enters the left eye image display period. In other words, the voltage applied to both the first liquid crystal panel assembly 11R and the second liquid crystal panel assembly 12R falls to 0 from V1, and thereby, in the right eye liquid crystal shutter 10a, the light transmittance in the liquid crystal shutter 10a in which the first liquid crystal panel assembly 11R and the second liquid crystal panel assembly 12R overlap with each other becomes 0. Therefore, the right eye liquid crystal shutter 10a enters the closing state of blocking the image light for the left eye image PL, and thus the right eye RE of the viewer does not recognize the left eye image PL.

After the left eye image display period has elapsed, the liquid crystal glasses 51 transfer the left eye liquid crystal shutter 10b to the closing state. In other words, in the state where the rising state of the voltage applied to the first liquid crystal panel assembly 11L is maintained, the voltage applied to the second liquid crystal panel assembly 12L rises. Thereby, the phase difference in the second liquid crystal panel assembly 12L decreases to 0, and the total phase difference in the left eye liquid crystal shutter 10b becomes 0. For this reason, the light transmittance in the liquid crystal shutter 10b becomes 0, that is, the liquid crystal shutter 10b is transferred to the closing state of blocking image light for the left eye image PL.

When the left eye liquid crystal shutter 10b is transferred to the closing state, since the rise in the voltage applied to the second liquid crystal panel assembly 12L is used, the phase difference can decrease from R1 to 0 for a relatively short delay time ΔT1 (much shorter than the delay time ΔT2 when the phase difference varies during the fall in the applied voltage). Therefore, when the left eye liquid crystal shutter 10b is transferred to the closing state, the transmittance can steeply vary.

If the right eye image display period starts after the left eye image display period is finished, at this time, the right eye liquid crystal shutter 10a is transferred to the opening state while the left eye liquid crystal shutter 10b is maintained to be in the closing state, but, both of the liquid crystal shutters 10a and 10b are in the closing state during a predetermined period at that time.

That is to say, at the time of changing between the left eye image display and the right eye image display, the viewer is prevented from viewing both of the left eye image and the right eye image by maintaining the liquid crystal shutters 10a and 10b to be in the closing state for a short time. Since human eyes have after-images, if the right eye image is displayed immediately after the left eye image disappears, both the left eye image and the right eye image are seen in a blurred state (crosstalk) since the after-image of the left eye image remains. When the changing between the left eye image display and the right eye image display is performed, both the liquid crystal shutters 10a and 10b are maintained to be in the closing state for a short time, thereby preventing this crosstalk.

When the left eye image display period starts, the liquid crystal glasses 51 are transferred to the opening state of the right eye liquid crystal shutter 10a. In the state where a voltage applied to the second liquid crystal panel assembly 12R is maintained to be 0 (to fall), a voltage applied to the first liquid crystal panel assembly 11R rises to V1. Thereby, the phase difference in the first liquid crystal panel assembly 11R decreases from R1 to 0. As a result, the phase difference (the total phase difference) in the liquid crystal shutter 10a in the state where the first liquid crystal panel assembly 11R of the phase difference 0 overlaps with the second liquid crystal panel assembly 12R of the phase difference R1 becomes λ/2. Therefore, the transmittance of light in the liquid crystal shutter 10a becomes D1, thus the right eye liquid crystal shutter 10a enters a state of transmitting image light for the right eye image PR, and thereby the right eye RE of the viewer can recognize the right eye image PR.

When the liquid crystal shutter 10a is transferred from the closing state to the opening state, since the rise in the voltage applied to the first liquid crystal panel assembly 11R is used, the phase difference can decrease from R1 to 0 for a relatively short delay time ΔT1 (much shorter than the delay time ΔT2 when the phase difference varies during the fall in the applied voltage). Therefore, when the liquid crystal shutter 10a is transferred to the opening state, the transmittance can steeply vary.

In addition, if the stereoscopic image display device 52 enters the right eye image display period, in order to prepare for the subsequent left eye image display period, the voltage applied to each of the first liquid crystal panel assembly 11L and the second liquid crystal panel assembly 12L falls to 0 from V1 in the left eye liquid crystal shutter 10b. It is preferable that the fall in the applied voltage during the closing period is performed at the same timing in the first liquid crystal panel assembly 11L and the second liquid crystal panel assembly 12L.

In other words, since the slow axes of the first liquid crystal panel assembly 11L and the second liquid crystal panel assembly 12L overlap with each other so as to be substantially perpendicular to each other, if the respective phase differences in the first liquid crystal panel assembly 11L and the second liquid crystal panel assembly 12L are equally varied by the same variation speed, the mutual phase differences in the liquid crystal panel assemblies cancel each other out, and thus the total phase difference in the first liquid crystal panel assembly 11L and the second liquid crystal panel assembly 12L is maintained to be 0.

After the right eye image display period has elapsed, the liquid crystal glasses 51 transfer the right eye liquid crystal shutter 10a to the closing state. In other words, in the state where the rising state of the voltage applied to the first liquid crystal panel assembly 11R is maintained, the voltage applied to the second liquid crystal panel assembly 12R rises. Thereby, the phase difference in the second liquid crystal panel assembly 12R decreases to 0, and the total phase difference in the right eye liquid crystal shutter 10a becomes 0. For this reason, the light transmittance in the liquid crystal shutter 10a becomes 0, that is, the liquid crystal shutter 10a is transferred to the closing state of blocking image light for the right eye image PR.

When the right eye liquid crystal shutter 10a is transferred to the closing state as well, since the rise in the voltage applied to the second liquid crystal panel assembly 12R is used, the phase difference can decrease from R1 to 0 for a relatively short delay time ΔT1 (much shorter than the delay time ΔT2). Therefore, when the right eye liquid crystal shutter 10a is transferred to the closing state as well, the transmittance can steeply vary.

Next, if the left eye image display period starts, both the liquid crystal shutters 10a and 10b are maintained to be in the closing state again after a predetermined period has elapsed, and the liquid crystal shutter 10b is transferred to the opening state from the closing state through the above-described process.

As described above, in the liquid crystal shutters 10a and 10b according to the embodiment of the invention, the first liquid crystal panel assemblies 11L and 11R the second liquid crystal panel assemblies 12L and 12R in which the phase difference decreases due to the application of a voltage overlap with each other, the fact is used that the variation speed in the phase difference is larger in the rise in the applied voltage than in the fall in the applied voltage. In addition, when the liquid crystal shutters 10a and 10b are transferred to the opening state, the rise in a voltage applied to the first liquid crystal panel assemblies 11L and 11R is used, and when the liquid crystal shutters 10a and 10b are transferred to the closing state, the rise in a voltage applied to the second liquid crystal panel assemblies 12L and 12R is used. Thereby, it is possible to transfer the right eye liquid crystal shutter 10a and the left eye liquid crystal shutter 10b from the closing state to the opening state at high speed. Therefore, it is possible to prevent the generation of a so-called crosstalk in which a viewer views the right eye image and the left eye image together, and to clearly view three-dimensional images without being blurred.

The entire disclosure of Japanese Patent Application No. 2010-053663, filed Mar. 10, 2010 is expressly incorporated by reference herein.

What is claimed is:

1. A liquid crystal device comprising:
a first liquid crystal panel assembly;
a second liquid crystal panel assembly that is formed to overlap with the first liquid crystal panel assembly, of which a slow axis is substantially perpendicular to a slow axis of the first liquid crystal panel assembly, and in which a phase difference increases or decreases due to application of a voltage in the same manner as the first liquid crystal panel assembly;
a pair of polarizers that is formed to be interposed between the first liquid crystal panel assembly and the second liquid crystal panel assembly; and
a control unit that independently controls the voltages applied to the first liquid crystal panel assembly and the second liquid crystal panel assembly.

2. The liquid crystal device according to claim 1, wherein the control unit performs a control such that a rise in the voltage applied to the first liquid crystal panel assembly and a rise in the voltage applied to the second liquid crystal panel assembly are performed at different timings, and a fall in the voltage applied to the first liquid crystal panel assembly and a fall in the voltage applied to the second liquid crystal panel assembly are performed at the same time.

3. The liquid crystal device according to claim 2, wherein a timing when the fall in the voltage applied to the first liquid crystal panel assembly and the fall in the voltage applied to the second liquid crystal panel assembly are performed at the same time is within a period when a total phase difference in the first liquid crystal panel assembly and the second liquid crystal panel assembly becomes minimal.

4. Liquid crystal glasses comprising two liquid crystal devices according to claim 1 which are disposed in parallel, wherein one liquid crystal device is used as a right eye shutter and the other liquid crystal device is used as a left eye shutter, and
wherein when an image display unit which alternately displays a right eye image and a left eye image in a time-divisional manner is viewed, the right eye shutter is opened and the left eye shutter is closed during a display period for the right eye image, and the right eye shutter is closed and the left eye shutter is opened during a display period for the left eye image.

5. The liquid crystal glasses according to claim 4, comprising a receiving unit that receives timing signals generated so as to correspond to display changing between the right eye image and the left eye image.

6. The liquid crystal glasses according to claim 4, wherein when display changing between the right eye image and the left eye image is performed, the right eye shutter and the left eye shutter are simultaneously closed only during a predetermined period.

7. A stereoscopic image system comprising:
a stereoscopic image display device that alternately displays a right eye image and a left eye image;
a timing signal generator that generates a timing signal corresponding to changing timing between the right eye image and the left eye image; and
the liquid crystal glasses according to claim 4, including a timing signal receiving unit that receives the timing signal generated from the timing signal generator.
